(19) United States
(12) Patent Application Publication
(10) Pub. No.: US 2011/0148123 A1
(43) Pub. Date: Jun. 23, 2011

(54) Zero-Emission Power Plant

(75) Inventor: Rik W.A.A. De Doncker, Leuven (BE)

(73) Assignee: Rheinisch-Westfalish- Technische Hochschule Aachen, Aachen (DE)

(21) Appl. No.: 13/060,955

(22) PCT Filed: Aug. 13, 2009
(86) PCT No.: PCT/EP09/05872

§ 371 Date: Feb. 25, 2011

(30) Foreign Application Priority Data
Aug. 25, 2008 (DE) 10 2008 039 449.1

(51) Int. Cl. H02K 7/18; F03D 9/02; F03D 9/00; H02J 3/38

(52) U.S. Cl. 290/1 R; 290/50; 290/55; 307/43

(57) ABSTRACT

There is provided a power plant in which a fossil fuel is used to generate power. An exemplary power plant includes a generator and a turbine that drives the generator, which generates electricity. Also included is a separator with which carbon dioxide is separated out of exhaust gas of the power plant. The power plant further includes a compressor with which the separated carbon dioxide is liquefied, the compressor being coupled to an electric drive.

### CROSS-REFERENCE TO RELATED APPLICATIONS

Pursuant to 35 U.S.C. §371, this application is the United States National Stage Application of International Patent Application No. PCT/EP2009/005872, filed on Aug. 13, 2009, the contents of which are incorporated by reference as if set forth in their entirety herein, which claims priority to German (DE) Patent Application No. 10 2008 039 449.1, filed Aug. 25, 2008, the contents of which are incorporated by reference as if set forth in their entirety herein.

### BACKGROUND

One of the causes for the climate changes that have increasingly been observed in recent years is ascribed to the emission of so-called greenhouse gases. The group of greenhouse gases includes carbon dioxide (CO₂). In view of this realization, many nations have ratified the Kyoto Protocol, which went into force in 2005. In this protocol, many industrialized nations have obliged themselves to gradually reduce their CO₂ emissions. A crucial starting point in achieving these goals is to reduce CO₂ emissions in the generation of power. This eco-political goal goes hand in hand with a genuine economic interest, since the emitter must have appropriate certificates for CO₂ emissions, the costs of which will rise in the future.

In this vein, on the one hand, there is a growing interest in the generation of power from renewable resources, and on the other hand, there is an increased interest in reducing or, in the best-case scenario, completely eliminating the CO₂ emissions of power plants in which fossil sources of energy are burned.

In power plants that use fossil sources of energy such as, for example, coal, the exhaust gases are already freed of minerals and dust particles by means of electrostatic filters. In order to capture the carbon dioxide, CO₂ is separated from the purified exhaust gases and compressed by means of a compressor, whereby the carbon dioxide is liquefied for purposes of storage or transportation. For this purpose, the state of the art proposes driving the compressor with an auxiliary turbine that is supplied with steam that has been diverted from the main turbine of the power plant. The efficiency of the power plant is reduced, not only because of the energy requirement of the auxiliary turbine that lowers the total efficiency of the power plant, but also because the steam flow to the main turbine is changed and the valve regulation for regulating the output of the auxiliary turbine gives rise to losses. It can be estimated that 12% of the output of the power plant is lost with this approach. The reason for this is that a steam turbine is optimized in such a way that it reaches its highest possible efficiency at its rated output when it is being operated a defined rotational speed and at a defined frequency and voltage of the generator. Deviations from these optimal rated value settings diminish the efficiency of the main turbine. The efficiency of the main turbine is further reduced because all of the secondary and auxiliary aggregates continue to run at their rated outputs, which are dimensioned for a higher output of the main turbine. The reason is that the dimensioning of the secondary aggregates does not take into account the output reduction of the main turbine due to the connection of the auxiliary turbine. As a rule, this means that the secondary and auxiliary aggregates consume more energy than would actually be necessary. All in all, this leads to the estimate that approximately 12% of the output of the main turbine is used up to liquefy the CO₂ by means of a compressor that is driven by an auxiliary turbine. Such an approach is disclosed, for example, in European patent application EP 0 551 876 B1.

Moreover, the discharge of supercritical steam from the main turbine calls for structural measures that are expensive and difficult to carry out. For these reasons, retrofitting already existing power plants with this concept is not feasible.

Another aspect of the known power plants is that these large units cannot start quickly and they are not capable of performing a black start since no energy storage means are available to supply power to the auxiliary and secondary aggregates such as pumps, control units and fans. For the person skilled in the art, the term black start means that a power plant is capable of starting up from a standstill without requiring power from the power supply grid. Moreover, off-grid operation is not possible since not every power plant has access to frequency regulating means. Regulation using the primary output with the objective of obtaining a lower output is very inefficient since the steam boiler has to be kept at full steam pressure so that the output can be quickly ramped up in case of an output fluctuation.

Before this backdrop, there is a need for power plants that burn fossil fuels as the primary source of energy but that release less CO₂ into the atmosphere than conventional power plants, especially during partial load operation. In the ideal scenario, a power plant should not release any CO₂ into the atmosphere, in spite of its using fossil sources of energy. In this case, one speaks of a zero-emission power plant or an emission-free power plant, even though combustion gases other than CO₂ such as, for example, nitrogen oxides (NOₓ) continue to escape into the atmosphere.

### SUMMARY

Exemplary embodiments of the invention relate to a power plant in which electricity is generated from fossil fuel, whereby the carbon dioxide emissions of the power plant are reduced. Moreover, exemplary embodiments relate to an energy supply system in which a number of power plants are connected to each other via a power supply grid.

According to an exemplary embodiment, a power plant is proposed in which a fossil fuel is used to generate power. A turbine drives a generator, which generates electricity. The power plant has a separator with which carbon dioxide is separated out of the exhaust gas of the power plant. The power plant also has a compressor with which the separated carbon dioxide is liquefied. According to an exemplary embodiment, the compressor is coupled to an electric drive. An advantage of the power plant according to an exemplary embodiment of the invention is that less primary energy is consumed to separate the carbon dioxide from the exhaust gases and to liquefy it than is the case in systems known from the state of the art.

In one embodiment of the invention, the turbine can be a steam turbine, whereby the power plant comprises a boiler in which the fossil fuel is burned in order to generate steam for the turbine that drives the generator.

In an exemplary embodiment of the invention, the generator supplies the generated electricity to an alternating-voltage medium-voltage network. In this case, it is advantageous for the electric drive of the compressor to be connected to the alternating-voltage medium-voltage network in order to obtain its electric power.

It may be advantageous if the electric drive of the compressor allows variable speeds, which favorably impacts on the efficiency of the power plant since, in this manner, the compressor can be efficiently adapted to the actual operating state of the power plant.

In a preferred embodiment of the invention, a converter is connected to the alternating-voltage medium-voltage network in order to generate direct current that is converted by an inverter into an alternating voltage for purposes of supplying the electric drive of the compressor with power. The converter can be an active rectifier that can also compensate for reactive power (fundamental-wave and harmonic reactive power).

It has proven to be especially advantageous for the converter and the inverter to be connected to each other via a direct-current medium-voltage network. Regenerative sources of energy and electric energy storage devices can be integrated into this direct-current medium-voltage network with relatively little effort. Wind parks are especially good options when it comes to regenerative sources of energy.

Advantageously, another inverter can be connected to the direct-current medium-voltage network, and it can supply power to secondary electric aggregates of the power plant. In this case, it is especially advantageous for the secondary aggregates to have electric drives with variable speeds, since in this manner, additional efficiency advantages can be achieved in terms of the energy requirements of the power plant, especially in the partial load range.

In another exemplary embodiment of the invention, the power plant is connected to an electric energy storage device. The energy storage device can quickly compensate for brief fluctuations in the energy demand in a power supply grid, and furthermore, it gives the power plant the capabilities for a black start.

It has proven to be advantageous if the energy storage device consists of an electric battery or of a plurality of electric batteries that are connected to each other. These can be, among other things, lead batteries that are inexpensive and have a long service life.

The energy storage device can be set up inside or outside of the power plant. Here, it is also possible for a single energy storage device to serve as the energy storage device for several power plants. Fundamentally speaking, mixed forms are also possible here, so that a great deal of flexibility is inherent in the design of the energy storage device in order to adapt it to the prevailing conditions.

It has proven to be advantageous for the energy storage device to be connected to the direct-current medium-voltage network of the power plant.

In order to adapt the operating voltage of the energy storage device to the operating voltage of the direct-current medium-voltage network, it is advantageous for the energy storage device to be connected via a direct-voltage converter to the direct-current medium-voltage network of the power plant.

In one embodiment of the power plant according to the invention, a wind farm is connected to the direct-current medium-voltage network. In this manner, it is particularly easy to integrate the fluctuating energy production of a wind farm into an electricity supply grid.

An exemplary embodiment of the invention provides energy supply system comprising a number of power plants according to the invention that are connected to each other in a power supply grid. Here, it is provided that several of the power plants each have an energy storage device. An advantage of the power supply system according to an exemplary embodiment of the invention is that load fluctuations in the power supply grid can be compensated for from the energy storage devices without a power plant having to be kept in standby operation, which is currently the case. This alone can already cut back on considerable amounts of CO₂, without even taking into account a possible CO₂ sequestration.

### BRIEF DESCRIPTION OF THE DRAWINGS

The drawing shows conventional power plants as well as two exemplary embodiments of the invention. In the figures, the same or equivalent elements have been labeled with the same reference numerals. The following is shown:

FIG. 1 a block diagram of a conventional power plant without carbon dioxide sequestration;

FIG. 2 a block diagram of a conventional power plant with carbon dioxide sequestration;

FIG. 3 a block diagram of a first exemplary embodiment of a power plant according to the invention with carbon dioxide sequestration; and

FIG. 4 a block diagram of a second exemplary embodiment of a power plant according to the invention with carbon dioxide sequestration.

### DETAILED DESCRIPTION OF SPECIFIC EMBODIMENTS

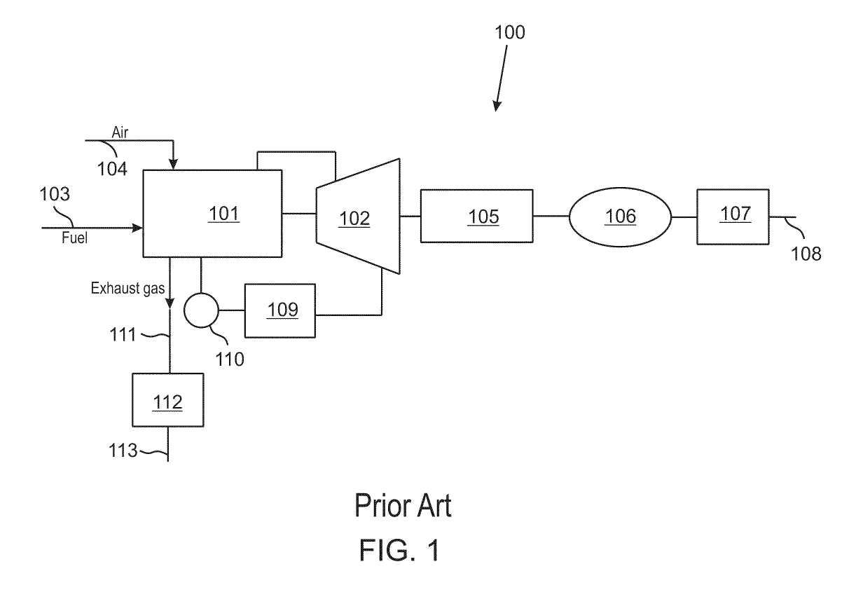

FIG. 1 shows a schematic block diagram of a conventional power plant that generates electricity by burning fossil fuels, whereby the CO₂ thus formed is released into the atmosphere. The power plant is designated in its entirety with the reference numeral 100. The power plant is supplied with a fossil fuel as the primary source of energy. This includes, for example, natural gas, oil and coal, which are most frequently used for generating electricity. The fuel is burned in a boiler 101 in order to generate high-pressure steam suitable for driving a turbine 102 which will be referred to below as the main turbine. The fuel is injected into the combustion chamber of the boiler 101 via a fuel line 103. The fuel burns in the combustion chamber of the boiler with combustion air that is supplied via an air feed line 104. When coal is used as the fuel, then the coal is ground into dust in a coal mill, not shown in FIG. 1 before being burned. In the main turbine 102, the energy stored in the steam is converted into mechanical energy, which is delivered to the output shaft of the main turbine 102. The output shaft of the main turbine 102 drives a generator 105 that converts the mechanical energy into electric energy. The electric energy delivered by the generator 105 is delivered to an alternating-current medium-voltage network 106 and from there, it is fed to a high-voltage transformer 107. The high-voltage transformer 107 transforms the medium voltage from the generator, for example, in the magnitude of 30 kilovolt, into a transport voltage of, for example, 380 kilovolt or 220 kilovolt, so that the energy can be carried away through a transmission line 108 with the smallest possible losses.

The power plant also has a condenser 109 that uses a cooling circuit to convert steam into water. Water is fed into the boiler via a pump 110. As an example for such an auxiliary aggregate, FIG. 1 shows a pump 110 that pumps feed water into the boiler 101. The pump 110 is driven electrically via synchronous or asynchronous machines, that is to say, the speed of the pump is rigidly coupled to the grid frequency. Additional such auxiliary aggregates needed in the power plant 100 are fans and cooling water pumps which, for the sake of clarity, are not shown in FIG. 1. The auxiliary aggregates are supplied with power from the electric energy generated in the power plant. Typically, a power plant in operation consumes 5% to 8% of the generated electric power for its own requirements. The exhaust gases stemming from the combustion process taking place in the boiler 101 are discharged via an exhaust gas line 111. An electrostatic filter 112 removes mineral particles and dust from the exhaust gases which are then released via a smokestack 113 into the atmosphere. By nature, the exhaust gases stemming from the combustion process of fossil sources of energy contain large amounts of CO₂.

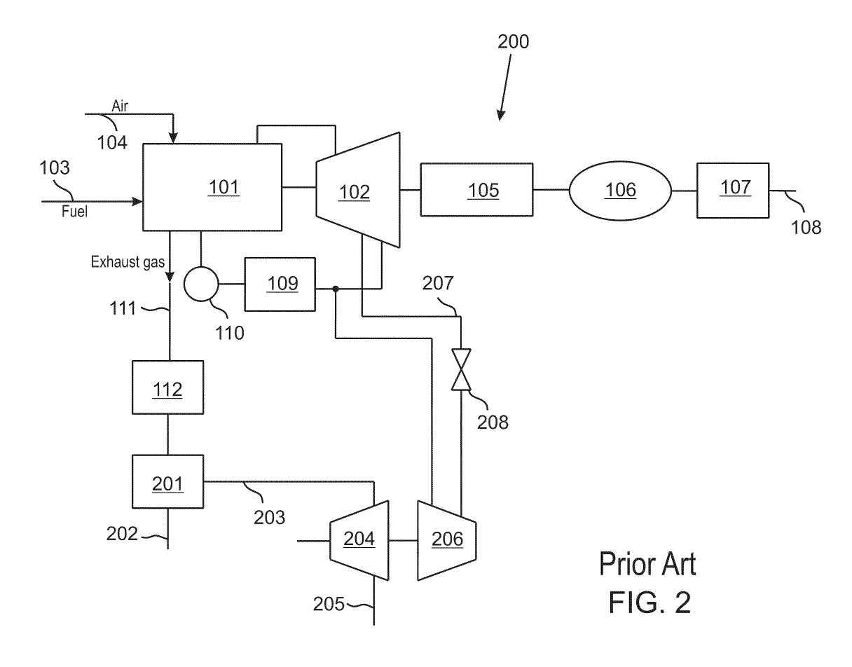

FIG. 2 shows a schematic block diagram of a conventional power plant with CO₂ sequestration. The power plant is designated in its entirety with the reference numeral 200. The term CO₂ sequestration means the storage of the CO₂, for example, in suitable geological formations such as abandoned salt mines, natural gas deposits, coal seams or oil deposits. CO₂ sequestration is an integral part of the efforts on the part of the European Union to reduce the carbon dioxide emissions from burning fossil fuels. These efforts are also known by the term “CCS process” (Carbon Dioxide Capture and Storage). The power plant 200 has the same structure as the power plant 100 shown in FIG. 1 in terms of the components that serve to generate power in the power plant. The difference between the power plant 200 and the power plant 100 lies in additional modules that serve to separate CO₂ from the combustion exhaust gases stemming from the boiler 101. After the separation, the CO₂ is in gaseous form and still has to be liquefied, since the CO₂ has to be available in liquid form for the sequestration. The components needed for this purpose will be briefly described below.

The combustion exhaust gases exit the electrostatic filter 112 after having been purified and are fed, for instance, to a scrubber 201 that serves as the separation device for CO₂. In the scrubber 201, the gaseous CO₂ is incorporated into a CO₂-absorbing liquid at a first temperature and subsequently expelled again from the absorbing liquid at a higher temperature, after which the CO₂ is present in pure form. The absorbing liquid can be, for example, an amine into which carbon dioxide is incorporated at 27° C. [80.6° F.] and released again at 150° C. [302° F.]. Such systems are known in the state of the art and are thus not described here in detail, since the manner in which the CO₂ gas is separated out is not of relevance for the techniques described herein. In coal power plants, CO₂ makes up about 15% of the flue gas released by the combustion process. The other gas fractions, from which the CO₂ has been removed, leave the scrubber 201 through a smokestack 202 and are released into the atmosphere. The gaseous CO₂ is fed via a line 203 into a compressor 204 where is it compressed to such a extent that it is converted into the liquid phase. Consequently, the compressor 204 makes liquid CO₂ available at an output line 205, from where it is transported away, for example, via a pipeline or by means of transport containers for purposes of final sequestration.

In the embodiment shown in FIG. 2, the compressor 204 is driven by an auxiliary turbine 206. The auxiliary turbine 206 is supplied with steam via a feed line 207 that is branched off from the main turbine 102. In the feed line 207, there is a restriction valve 208 with which the rotational speed or the output of the auxiliary turbine 206 is regulated. The auxiliary turbine 206, like all of the other aggregates of the power plant 200, is regulated by the control unit 109.

From today's vantage point, this approach is not optimal since, with this construction, approximately 12% of the output of the main turbine 102 is lost. The reasons for this were already mentioned above. One of the main reasons is that already simply branching off the steam from the main turbine leads to a reduction in its efficiency. The control via a restriction valve 208 causes enthalpy losses, as a result of which the efficiency is further diminished.

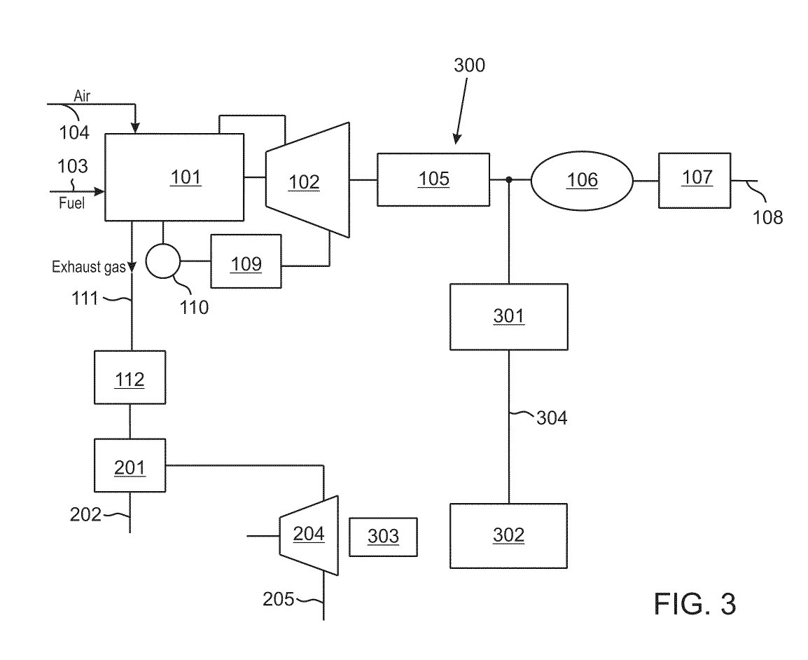

FIG. 3 shows a schematic block diagram of a power plant according to an exemplary embodiment of the invention with CO₂ sequestration. The power plant is designated in its entirety with the reference numeral 300. In an exemplary embodiment, the auxiliary turbine 206 of the power plant 200 shown in FIG. 2 is replaced by an electric drive with a variable speed in order to achieve a higher overall efficiency of the power plant 300 as compared to the power plant 200. For this purpose, a converter 301 is provided that can be configured as a passive rectifier or as an active rectifier. An active rectifier actually consists of an inverter circuit that operates in the rectification mode. Active rectifiers are capable of bidirectionally regulating the active and reactive outputs independently of each other, and they are nowadays the preferred methodology when it comes to variable electric drives in the medium-voltage range. The alternating voltage generated by the inverter 302 supplies power to an electric machine, for example, an induction motor 303. Induction motors and synchronous machines are typically used in this output range.

However, exemplary embodiments of the invention are not limited to a certain type of electric motor. It is merely necessary that the power output of the electric machine 303 can be variably regulated via the inverter or converter 302. Typically, the electric machine 303 has a rated output of 40 megawatts at a power plant output of 800 MW. In general, the electric machine 303 has a rated output that is approximately 5% of the rated output of the power plant. Electrically driven compressors in this output range are used, for instance, in installations for liquefying natural gas. Such electric drives are commercially available. The converters 301 and 302 are configured in such a way that both of them are capable of converting direct current into alternating current and vice versa.

Power converters are used to actuate the electric machine. Nowadays, power converters are structured modularly in order to form so-called PEBBs (Power Electronic Building Blocks). IGBTs (Insulated Gate Bipolar Transistors) or GCTs (Gate Commutated Thyristors) are used in series or parallel circuits in order to create voltage converters that reach an output in the order of magnitude of more than 40 megawatts.

It is a known procedure to use heavy-duty circuit breakers in the form of GTOs (Gate Turn-off Thyristors) or GCTs as well as IGBTs, for example, in converters. These semiconductor elements are switched on by a gate current pulse. In the case of the GTO, part of the anode current is brought out of the semiconductor via the gate in order to switch off the components; in the case of the GCT, in fact, all of the anode current is brought out.

As a result, these voltage converters have an inner direct-voltage bus or a direct-voltage network 304. An advantage of this concept is that the interconnection of standardized components allows different rating classes of the PEBBs to be set up in a cost effective manner.

The electric drive for the compressor 204, that is to say, the converter 301, the inverter 302 and the electric machine 303 have an efficiency of over 95%. The compressor 204 is regulated by an inverter that regulates the speed or the output of the electric machine 303. In this manner, no valve control, for example, with restriction valves, is needed by the compressor, and consequently, losses are minimized. An estimate has shown that the compressor system consumes approximately 6% of the total output of the electric power generated by the main turbine. The direct-voltage bus 304 of the electric drive is supplied with electricity by a 3-phase electric rectifier on the grid which, in the embodiment shown in FIG. 3, is dimensioned in accordance with the active output of the compressor drive.

Moreover, it is a known fact that the converter 301 can provide a very fast VAR control so that the reactive power can be adapted very quickly. This means that the exciter of the generator, namely, its field winding, can be configured for slower changes, which reduces its costs.

The electric drive according to an exemplary embodiment of the invention can be retrofitted into existing power plants in a very simple manner. Based on an estimate, the separation of the carbon dioxide from the exhaust gases reduces the overall efficiency of the power plant by approximately 6% of the initial rated output.

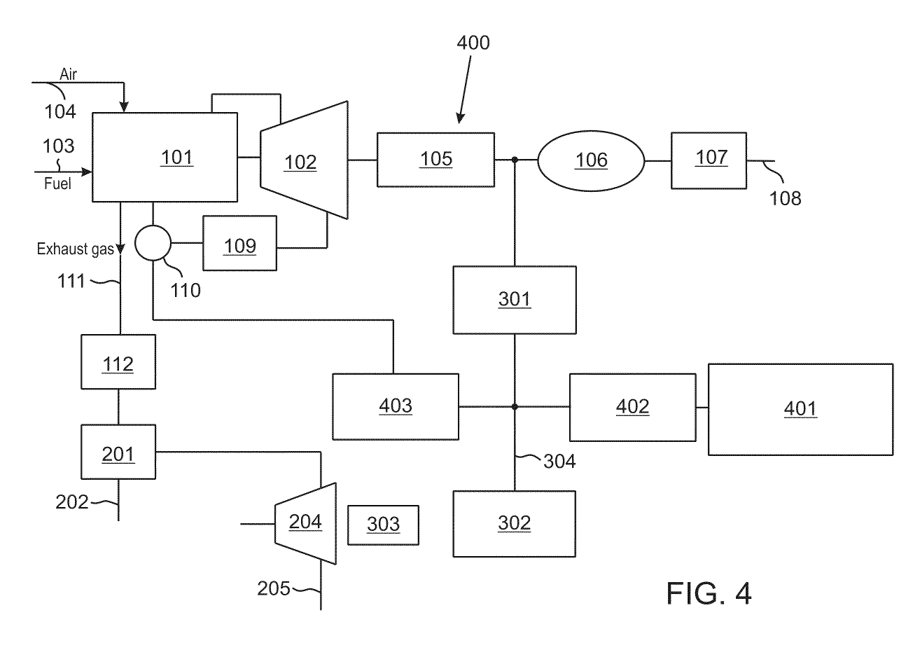

FIG. 4 shows a schematic block diagram of a second embodiment of a power plant according to an exemplary embodiment of the invention with CO₂ sequestration. The power plant is designated in its entirety with the reference numeral 400. In this embodiment, an electric energy storage device 401 is connected to the direct-voltage bus 304. The energy storage device can be, for example, lead batteries, which are relatively inexpensive. Sodium sulfur batteries, which have a long service life, are also economically employed nowadays. The energy storage device 401 is connected to the direct-voltage bus 304 with a direct voltage converter (DC/DC converter) 402. In this case, during inverter operation, the converter 301 on the grid can impart black start capabilities to the power plant 400 that is equipped in this manner.

For the person skilled in the art, the term black start means that a power plant is capable of starting up from a standstill without requiring power from the power supply grid. All of the secondary aggregates of the power plant 400 can be supplied via the direct-voltage bus 304, which behaves like an uninterruptible power supply (UPS). Consequently, the power plant 400 according to an exemplary embodiment of the invention is suited for off-grid operation since a voltage control (VAR control) is possible due to the fact that the active rectifier 301 is used for this purpose.

Moreover, the storage of energy in batteries in the energy storage device 401 allows a very fast response to an increased power demand in the grid. The response can take place much more quickly than is possible, for example, in a pumped-storage hydroelectric plant.

It is provided that the energy storage device 401 can yield an output of at least 5% of the rated output of the power plant over a period of 8 hours. In an 800-megawatt power plant, 5% of the rated output equals 40 megawatts. If a considerable number of such energy storage devices are distributed over a considerable number of power plants, it is also possible to completely shut down power plants that are merely on stand-by and to meet a temporarily increased power demand exclusively from the electric energy storage devices 401. The energy storage devices 401 can be located decentrally in individual power plants or else centrally in a grid that encompasses several multiple power plants.

It takes about one hour for a shut-down power plant with a cold boiler to be powered up to its rated output. With the electric energy storage devices 401, it is easy to bridge this period of time. The mere fact that a power plant is shut down completely and does not continue to run in the standby mode—even without CO₂ sequestration—already leads to a considerable reduction in CO₂ emissions from power generation as compared to today's technology.

Another feature of an exemplary embodiment of the invention is the fact that the primary control function of the generator, which depends on the dimensioning of the grid inverter, is shifted to the inverter on the grid. Consequently, the generator 105 can be switched off completely and thus considerable standby losses can be avoided. The shared medium-voltage direct-voltage bus 304 can supply other inverter supply consumers throughout the power plant 400. These include all of the pumps and fans. For this purpose, another inverter 403 is provided that is connected to the direct-voltage bus 304. This structure of the power plant 400 allows the power plant to be controlled more flexibly during partial operation and when it is being powered up, which improves the efficiency and the dynamics in such a way that the power plant can be powered up more quickly.

The use of medium-voltage direct-voltage cables (not shown in FIG. 4) makes it possible for nearby regenerative power generators such as, for example, wind generators to be connected directly to the direct-voltage network 304 of the power plant 400. Through the use of the batteries 401 of the power plant 400, fluctuations in the wind power can be compensated for and in this manner, a constant power output to the high-voltage grid 108 can be achieved. The inverter or active rectifier 301 on the grid has to be dimensioned for the rated output of the wind farm and the for the requisite reactive power compensation.

For wind farms, the use of direct-current networks for collecting and transmitting the electric energy generated by numerous wind turbines has already been proposed in numerous publications such as, for example, by C. Meyer and R. De Donker in “Design of a three-phase series resonant converter for offshore dc grids” in 42^{nd} Annual Meeting Industry Applications Conference, Conference Record of the 2007 IEEE, 2007, pages 216 to 223.

Since the inverter on the grid has a high bandwidth of several kilohertz, harmonic and subharmonic oscillations can be compensated for without additional filter circuits in that power is acquired from the batteries.

Even though the invention has been described in conjunction with a power plant in which fossil fuels are burned in a boiler 101 in order to generate steam for a steam turbine, the invention can fundamentally also be applied to power plants in which natural gas is burned in gas turbines.

1-18. (canceled)

19. A power plant in which a fossil fuel is used to generate power, the power plant comprising:
a generator;
a turbine that drives the generator, which generates electricity;
a separator with which carbon dioxide is separated out of exhaust gas of the power plant; and
a compressor with which the separated carbon dioxide is liquefied, the compressor being coupled to an electric drive.

20. The power plant recited in claim 19, wherein the turbine is a steam turbine, the power plant comprising a boiler in which the fossil fuel is burned in order to generate steam for the turbine that drives the generator.

21. The power plant recited in claim 19, wherein the generator supplies the generated electricity to an alternating-voltage medium-voltage network.

22. The power plant recited in claim 19, wherein the electric drive of the compressor is connected to the alternating-voltage medium-voltage network in order to obtain its electric power.

23. The power plant recited in claim 19, wherein the electric drive of the compressor allows variable speeds.

24. The power plant recited in claim 19, comprising a converter that is connected to the alternating-voltage medium-voltage network in order to generate direct current that is converted by an inverter into an alternating voltage for purposes of supplying the electric drive of the compressor with energy.

25. The power plant recited in claim 24, wherein the converter is an active rectifier.

26. The power plant recited in claim 24, wherein the converter and the inverter are connected to each other via a direct-current medium-voltage network.

27. The power plant recited in claim 26, comprising another inverter that is connected to the direct-current medium-voltage network, and it can supply power to secondary electric aggregates of the power plant.

28. The power plant recited in claim 27, wherein the secondary electric aggregates have electric drives with variable speeds.

29. The power plant recited in claim 19, wherein the power plant is connected to an electric energy storage device.

30. The power plant recited in claim 29, wherein the energy storage device is connected via a direct-voltage converter to the direct-current medium-voltage network of the power plant.

31. The power plant recited in claim 30, wherein the energy storage device includes an electric battery or a plurality of electric batteries that are connected to each other.

32. The power plant recited in claim 31, wherein the energy storage device is connected to the direct-current medium-voltage network of the power plant.

33. The power plant recited in claim 31, wherein the energy storage device is set up outside of the power plant.

34. The power plant recited in claim 33, wherein a single energy storage device serves as the energy storage device for several power plants.

35. The power plant recited in claim 19, wherein a wind farm is connected to the direct-current medium-voltage network.

36. An energy supply system, comprising:
a plurality of power plants in which a fossil fuel is used to generate power, each of the plurality of power plant comprising:
a generator;
a turbine that drives the generator, which generates electricity;
a separator with which carbon dioxide is separated out of exhaust gas of the power plant; and
a compressor with which the separated carbon dioxide is liquefied, the compressor being coupled to an electric drive; and
wherein the plurality of power plants are connected to each other via a power supply grid, at least a subset of the plurality of power plants having an energy storage device associated therewith.

37. A method of generating power in a power plant in which a fossil fuel is used to generate power, the method comprising:
generating electricity via a turbine-driven generator;
separating carbon dioxide from exhaust gas produced by generating the electricity; and
liquefying the separated carbon dioxide.
